(19) United States
(12) Patent Application Publication
(10) Pub. No.: US 2023/0187126 A1
(43) Pub. Date: Jun. 15, 2023

(54) HIGH-FREQUENCY TRANSFORMER AND APPLICATIONS THEREOF

(71) Applicant: Griffith University, Nathan, Queensland (AU)

(72) Inventors: Junwei Lu, Nathan, Queensland (AU); Xiaokun Li, Nathan, Queensland (AU)

(21) Appl. No.: 17/924,055

(22) PCT Filed: May 7, 2021
(86) PCT No.: PCT/AU2021/050425

§ 371 Date: Nov. 8, 2022

(30) Foreign Application Priority Data
May 8, 2020 (AU) 2020901469

(51) Int. Cl. H01F 30/16; H01F 27/30; H01F 27/26

(52) U.S. Cl. CPC H01F 30/16; H01F 27/306; H01F 27/263; H01F 2038/003

(57) ABSTRACT

A high-frequency rotary transformer, a machine and a high frequency transformer are defined that are simpler to manufacture and less expensive than existing transformers and machines. The high-frequency rotary transformer includes: a primary transformer core comprising a plurality of primary core elements, each defining a primary transformer winding portion; a secondary transformer core comprising a plurality of secondary core elements, each defining a secondary transformer winding portion; a primary winding associated with each of the primary core elements; and a secondary winding associated with each of the secondary core elements. The primary transformer core and the secondary transformer core together define a transformer core having a flux pathway linking the primary and secondary windings, and the primary transformer core and the secondary transformer core are configured to rotate relative to each other. A magnetic flux concentrator may be used to direct magnetic flux towards an inside of the rotary transformer.

### TECHNICAL FIELD

The present invention relates to high-frequency transformers. In particular, although not exclusively, the invention relates to high-frequency rotary transformers for use in motors and generators.

### BACKGROUND ART

Conventional wound-rotor synchronous machines (SM) and doubly-fed induction machines (DFIM) are electromechanical transducers that convert mechanical energy into electrical energy or vice versa. They consist of both synchronous motors and synchronous generators. These machines consist of a stationary stator, typically comprising tight coils of copper wire wrapped around an iron core, and a rotating rotor, typically comprising coils of copper wire wrapped around an iron core or a permanent magnet.

In the case of a synchronous motor, direct current (DC) is supplied to the rotor to produce a stationary magnetic field, which in turn interacts with the stator magnetic field to produce torque at a shaft of the motor. Power to the rotor is supplied through a rotating interface comprising brushes at the stationary side and sliprings at the rotating side.

In the case of a synchronous generator, the rotor is rotated, and as the rotor passes the stator, AC electricity is produced. This is then converted into DC electricity which can either be fed into the electricity grid by using DC/AC inverter or stored in batteries. Such generators also include a rotating interface comprising brushes at the stationary side and sliprings at the rotating side.

A problem with such motors and generators of the prior art is that they are prone to damage and wear caused by mechanical contact between moving sliprings and wearing of static brushes. Furthermore, as brushes wear, powder is generated which can cause damage to insulation of the motor. In addition, any fault with the electrical contact can generate sparks resulting in limited application (e.g., use only in non-explosive environments). In summary, these machines exhibit unsatisfactory performance in regard to long-term durability (e.g., wear of brushes) and reliability (e.g., degradation of brush-to-slip-ring electrical contact in adverse environment).

Brushless motors have been developed in an attempt to overcome the above problems. Brushless motors comprise essentially a design that is the inverse of a traditional SM, outlined above, with permanent rare-earth magnets on the rotor instead of copper coils, and electromagnets on the stator instead of permanent magnets. Three-phase AC current is used to charge the electromagnets in the stator, causing them to rotate the rotor.

While brushless motors typically exhibit increased efficiency when compared with traditional SM motors, they have several disadvantages. In particular, the costs of permanent rare-earth magnets is high, and rare earth magnets are hazardous. Furthermore, high currents or temperatures can lead to demagnetisation of the permanent magnets.

Certain attempts have also been made to use rotary transformers instead of brushes and slip rings. However, rotary transformers have previously been large and heavy, and difficult to manufacture, and therefore not suitable for use in synchronous machines and doubly-fed induction machines.

As such, there is clearly a need for improved motors, generators and transformers.

It will be clearly understood that, if a prior art publication is referred to herein, this reference does not constitute an admission that the publication forms part of the common general knowledge in the art in Australia or in any other country.

### SUMMARY OF INVENTION

The present invention is directed to high-frequency transformers and related machines, which may at least partially overcome at least one of the abovementioned disadvantages or provide the consumer with a useful or commercial choice.

With the foregoing in view, the present invention in a first aspect resides broadly in a high-frequency rotary transformer including:

a primary transformer core comprising a plurality of primary core elements, each defining a primary transformer winding portion;

a secondary transformer core comprising a plurality of secondary core elements, each defining a secondary transformer winding portion;

a primary winding associated with each of the primary core elements; and

a secondary winding associated with each of the secondary core elements;

wherein the primary transformer core and the secondary transformer core together define a transformer core having a flux pathway linking the primary and secondary windings, and wherein the primary transformer core and the secondary transformer core are configured to rotate relative to each other.

Advantageously, the use of a plurality of primary and secondary core elements in such manner enables primary and secondary cores to be created in a modular manner. This in turn enables cores to be created which are larger and less expensive than existing cores.

Preferably, the primary transformer winding portion comprises a channel for receiving the primary transformer winding. Preferably, the secondary transformer winding portion comprises a channel for receiving the secondary transformer winding. Preferably, the channels of the primary transformer winding portions are arranged to provide a semi-continuous channel around an axis of the rotary transformer. Preferably, the channels of the secondary transformer winding portions are arranged to provide a semi-continuous channel around an axis of the rotary transformer.

Preferably, the channels of the primary transformer winding portions are facing corresponding channels of the secondary transformed winding portions.

Preferably, the primary and second core elements are arranged in pairs to define the transformer core.

Preferably, the primary and secondary core elements are at least partly U-shaped. Suitably, the primary and secondary core elements are U-shaped.

Preferably, the primary and secondary transformer cores are each substantially axially symmetrical.

Preferably, the primary and secondary transformer cores are substantially circular in shape.

Preferably, the primary core and the secondary core are separated by an air gap. Suitably, the air gap is less than 1 cm. Preferably, the air gap is about 1 mm.

Preferably, the primary and secondary transformer windings are each substantially toroidal in shape.

Preferably, the primary core and the secondary core comprise concentric core portions.

Alternatively, the primary core and the secondary core comprise axially separated core portions.

Preferably, the primary and secondary core elements each define multiple primary and secondary transformer winding portions, and the rotary transformer comprises a plurality of primary and secondary windings.

In some embodiments, the primary core elements each define two primary transformer winding portions and the and secondary core elements each define two secondary transformer winding portions. Suitably the primary and secondary core elements are E-shaped.

In other embodiments, the primary core elements each define three primary transformer winding portions and the secondary core elements each define three secondary transformer winding portions.

Preferably, the high-frequency rotary transformer includes a magnetic flux concentrator, configured to direct magnetic flux towards the primary and secondary core elements.

Suitably, the high-frequency rotary transformer includes a coil intermediate the magnetic flux concentrator and the primary and secondary core elements. Suitably, the coil is coupled to the primary winding.

Preferably, the transformer is configured to operate at a frequency of greater than 50 kHz.

In a second aspect, the invention resides broadly in an electric machine comprising a stationary stator and a rotating rotor, wherein a high-frequency rotary transformer according to the first aspect provides a contactless electrical coupling to the rotor.

Advantageously, the electric machine may avoid the need for brushes and slip-rings, which may in turn increase reliability of the machine, while remaining relatively low cost as it does not require the use of rare-earth magnets, as is the case for brushless motors.

The electric machine may comprise a synchronous machine. The electric machine may comprise a doubly-fed induction machine. The electric machine may comprise a motor. The electric machine may comprise a generator.

In another form, the invention resides broadly in a high frequency transformer including:

a primary transformer core comprising a plurality of primary core elements, each defining a primary transformer winding portion;

a secondary transformer core comprising a plurality of secondary core elements, each defining a secondary transformer winding portion;

a primary winding associated with each of the primary core elements; and

a secondary winding associated with each of the secondary core elements;

wherein the primary transformer core and the secondary transformer core together define a transformer core having a flux pathway linking the primary and secondary windings.

Advantageously, the use of a plurality of primary and secondary core elements in such manner enables primary and secondary cores to be created in a modular manner, e.g. as a solid-state transformer.

The high frequency transformer may be provided in a wind turbine. The wind turbine may be an off-shore wind turbine.

Preferably, the primary transformer winding portion comprises a channel for receiving the primary transformer winding. Preferably, the secondary transformer winding portion comprises a channel for receiving the secondary transformer winding. Preferably, the channels of the primary transformer winding portions are arranged to provide a semi-continuous channel around an axis of the rotary transformer. Preferably, the channels of the secondary transformer winding portions are arranged to provide a semi-continuous channel around an axis of the rotary transformer.

Preferably, the channels of the primary transformer winding portions are facing corresponding channels of the secondary transformed winding portions.

Preferably, the primary and second core elements are arranged in pairs to define the transformer core.

Preferably, the primary and secondary core elements are at least partly U-shaped. Suitably, the primary and secondary core elements are U-shaped.

Preferably, the primary and secondary transformer cores are each substantially axially symmetrical.

Preferably, the primary and secondary transformer cores are substantially circular in shape.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a front view of a rotary transformer, according to an embodiment of the present invention.

FIG. 2 illustrates a side cross-sectional view of a portion of the transformer of FIG. 1, through A-A′ of FIG. 1.

FIG. 3 illustrates a cross sectional view of a portion of a transformer, similar to the transformer of FIG. 1, according to an alternative embodiment of the present invention.

FIG. 4 illustrates a front view of a rotary transformer, according to an embodiment of the present invention.

FIG. 5 illustrates a side cross-sectional view of the transformer of FIG. 4, through B-B′ of FIG. 4.

FIG. 6 illustrates a front view of a magnetic flux concentrator, according to an embodiment of the present invention.

FIG. 7 illustrates a front view of a coil for use with the magnetic flux concentrator of FIG. 6, according to an embodiment of the present invention.

FIG. 8 illustrates a perspective view of the coil of FIG. 7 and the magnetic flux concentrator of FIG. 6.

FIG. 9 illustrates a front view of the magnetic flux concentrator of FIG. 6 illustrating current induced therein by the coil of FIG. 7.

FIG. 10 illustrates a cross-sectional view of an electric machine, according to an embodiment of the present invention.

FIG. 11 illustrates a schematic of an electric vehicle including the electric machine of FIG. 9, according to an embodiment of the present invention.

FIG. 12 illustrates a side cut-away view of a wind turbine, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

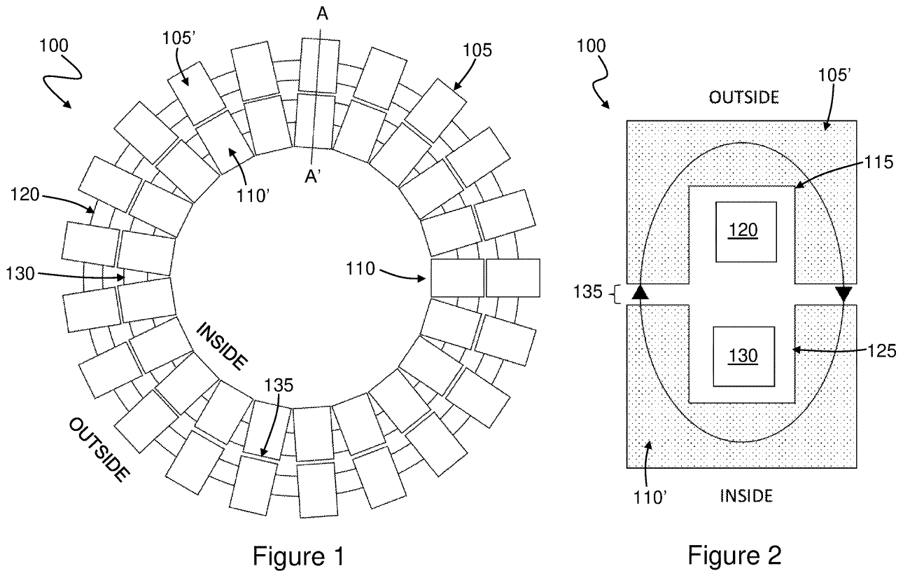

FIG. 1 illustrates a front view of a rotary transformer 100, according to an embodiment of the present invention. FIG. 2 illustrates a side cross-sectional view of a portion of the transformer 100 through A-A′ of FIG. 1.

The rotary transformer 100 is constructed of modular components, as outlined below, which enables transformer cores to be created which are larger and less expensive than existing cores. Furthermore, the rotary transformer 100, and variants thereof, is particular suited for motors and generators, as outlined below.

The rotary transformer 100 includes a primary transformer core 105, on an outside of the rotary transformer 100, and a secondary transformer core 110, on an inside of the rotary transformer. The primary magnetic core 105 comprises a plurality of U-shaped primary core elements 105′, circumferentially arranged to define the primary transformer core 105, and the secondary transformer core 110 comprises a plurality of U-shaped secondary core elements 110′, circumferentially arranged to define the secondary transformer core 105.

The primary core elements 105′ each define a channel 115 for receiving a primary transformer winding 120 and the secondary core elements 110′ similarly each define a channel 125 for receiving a secondary transformer winding 130. The primary core elements 105′ are arranged such that the channel 115 faces inwards towards an axis of the rotary transformer 100, and the secondary core elements 110′ are arranged such that the channel faces 125 outwards away from an axis of the rotary transformer 100. As such channels 115 and channels 125 are facing each other, and define semi-continuous channels around an axis of the rotary transformer 100.

The primary transformer core 105 and the secondary transformer core 110 together define a transformer core, which is spaced by an air gap 135, and which defines a flux pathway linking the primary and secondary windings 120, 130. As such, electrical energy is transferred from the primary transformer winding 120 to the secondary transformer winding 130 by the transformer core. The air gap 135 may be any suitable size, but is typically less than 1 cm, and may be around 1 mm. The skilled addressee will readily appreciate that large air gaps may negatively influence the system.

Each of the primary core elements 105′ are arranged in pairs with a secondary core element 110′, such that each pair defines a transformer sub-core defining a flux pathway. The primary transformer core 105 and the secondary transformer core 110 are able to rotate relative to each other, but as the primary core elements 105′ and secondary core elements 110′ are tightly spaced, the magnetic circuit defined by the transformer core is not broken by (and does not substantially change as a result of) any rotation. In particular, the primary and secondary core elements 105′, 110′ create new pairs when rotated which are identical to the pairs prior rotation, due to substantial axial symmetry of the transformer 100.

The primary and secondary transformer windings 120, 130 are each toroidal in shape and may substantially fill the respective channels 115, 125. While the above embodiment illustrates a single primary winding 120 and a single secondary winding 130, the skilled addressee will readily appreciate that any suitable number of windings may be used.

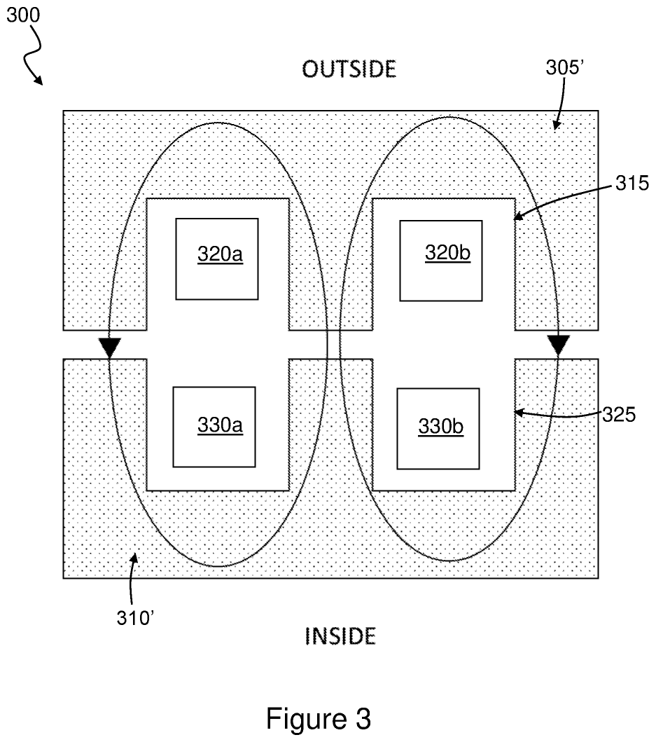

FIG. 3 illustrates a cross sectional view of a portion of a transformer 300, similar to the transformer 100, but with primary and secondary cores comprising core elements 305′, 310′ having an E-shape and thereby each defining two channels 315, 325.

In particular, the primary core elements 305′ define first and second primary channels 315, for receiving first and second primary transformer windings 320a, 320b. Similarly, the secondary core elements 310′ each define first and second secondary channels 325 for receiving first and second secondary transformer windings 330a, 330b. The first and second primary transformer windings 320a, 320b are spaced along an axial length of the transformer, and the first and second secondary transformer windings 330a, 330b are spaced along an axial length of the transformer such that the mirror each other in cross section.

Both the primary and secondary windings 320a, 320b, 330a, 330b can be connected in parallel or in series. The flux direction generated by two primary windings 320a, 320b connected in series in the centre leg will be the same direction.

The first primary transformer winding 320a and the first secondary transformer winding 330a are coupled by a first flux pathway in the transformer core, and the second primary transformer winding 320b and the second secondary transformer winding 330b are coupled by a second flux pathway in the transformer core, as illustrated by arrows in FIG. 3.

In addition to defining cores having multiple channels in each core element, the skilled addressee will readily appreciate that multiple core elements may be used to define the multiple primary and secondary channels.

Furthermore, while the above embodiment illustrates a primary transformer core 105 on an outside of the rotary transformer and a secondary transformer core 110 on an inside (i.e. the primary core and the secondary core comprise concentric core portions), other configurations may be used.

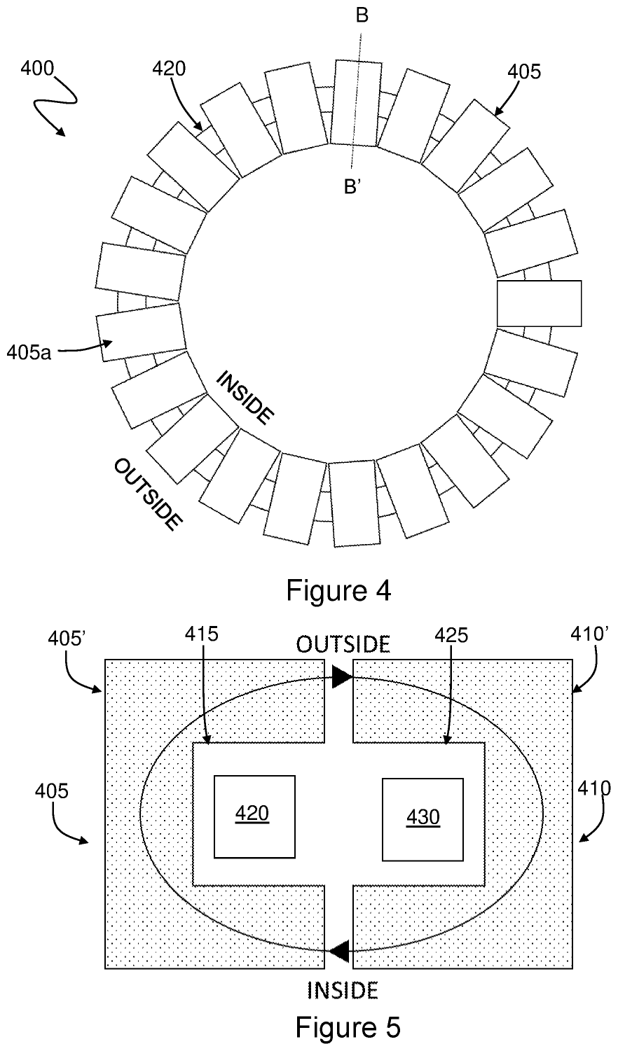

FIG. 4 illustrates a front view of a rotary transformer 400, according to an alternative embodiment of the present invention. FIG. 5 illustrates a side cross-sectional view of a portion of the transformer 400 through B-B′ of FIG. 4.

The transformer 400 is similar to the transformer 100, but includes a primary transformer core 405 and a secondary transformer core 410 in a side-by-side arrangement. The primary transformer core 405 is formed of primary core elements 405′ which are arranged such that a channel 415 faces in one direction along the axis of the rotary transformer 400, and the secondary core elements 410′, which define the secondary transformer core 410, are arranged such that a channel 425 therein faces in an opposite direction along the axis of the rotary transformer 400. As such channels 415 and channels 425 define semi-continuous channels around an axis of the rotary transformer 400 of the same size, and as such primary and secondary windings 420, 430 extend axially around the transformer in a side-by-side arrangement.

The rotary transformer 400 can be adapted to become a high frequency isolation transformer (stationary transformer) and a solid-state transformer by removing the air gap, without deviating from the scope of the present invention.

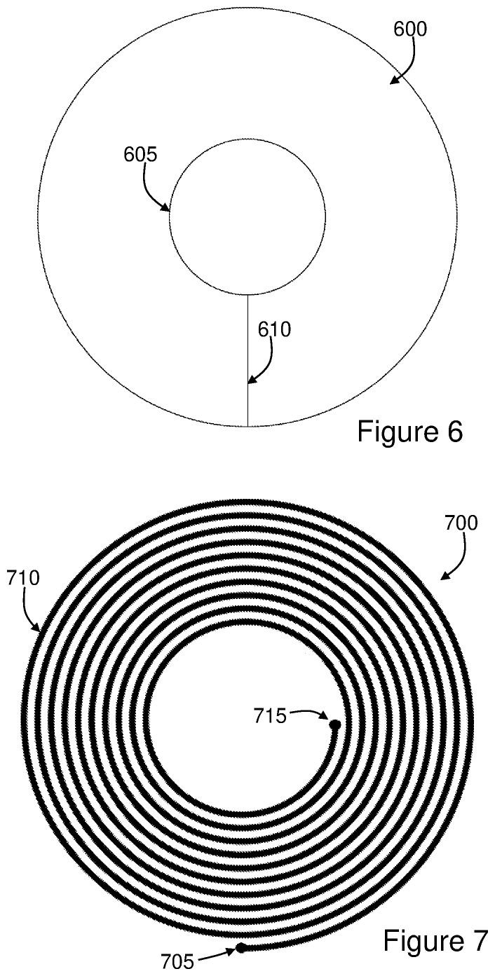

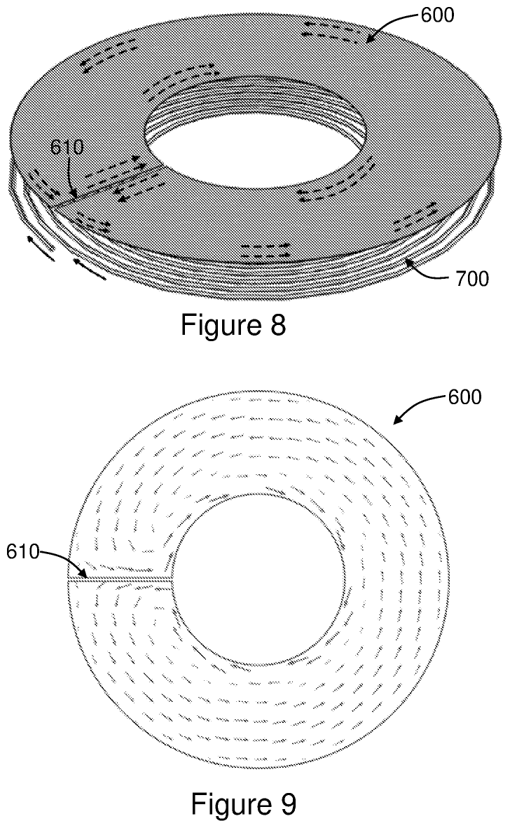

In order to prevent leakage flux and EMI reduction, the transformers described above may incorporate a magnetic flux concentrator (MFC). FIG. 6 illustrates a front view of a magnetic flux concentrator 600, FIG. 7 illustrates a front view of a coil 700 for use with the magnetic flux concentrator 600, FIG. 8 illustrates a perspective view of the coil 700 and the magnetic flux concentrator 600, and FIG. 9 illustrates a front view of the magnetic flux concentrator 600 illustrating current induced therein by the coil 700.

The magnetic flux concentrator 600 is shaped like an annular ring including a central aperture 605 and a slit 610 providing an air gap extending between the central aperture 605 and an outside of the ring, to redirect the induced current flow therethrough. The magnetic flux concentrator 600 is configured to be positioned on a side of a rotary transformer, and the central aperture 605 enables an inner shaft (e.g. coupled to the rotor) to extend therethrough.

The coil 700 is also shaped like the magnetic flux concentrator 600, but has a start 705, a coil portion 710, and an end 715. The coil 700 is configured to be positioned intermediate the magnetic flux concentrator 600 and the rotary transformer, and is configured to be positioned in line with the primary winding of the rotary transformer.

The magnetic flux concentrator 600 and coil direct magnetic flux towards primary and secondary core elements of the rotary transformer, and thus an inside of the rotary transformer and can thereby improve the magnetic coupling coefficient between primary and secondary transformer windings.

As outlined above, the rotary transformers described herein, and variations thereof, are particularly suited to electric machines, such as synchronous machines and doubly-fed induction machines.

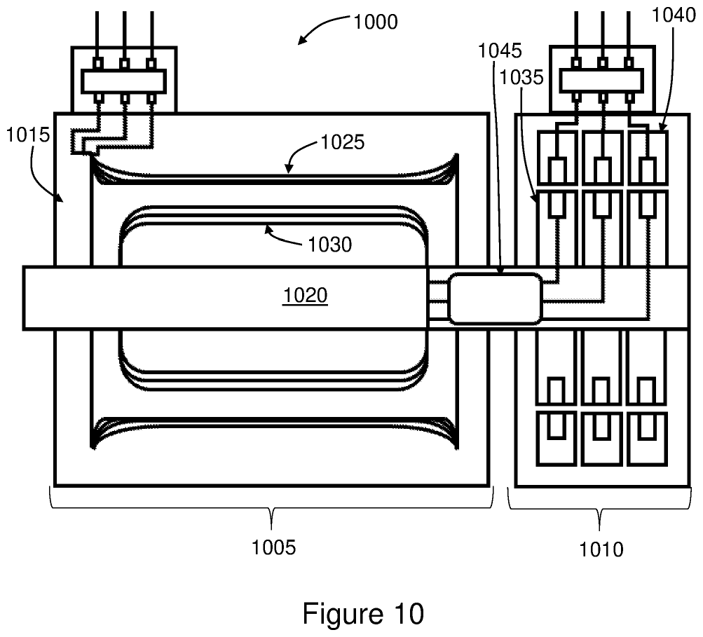

FIG. 10 illustrates a cross-sectional view of an electric machine 1000, according to an embodiment of the present invention. The electric machine 1000 avoids the need for brushes and slip-rings, which may in turn increase reliability of the machine 1000, while remaining relatively low cost as it does not require the use of rare-earth magnets, as is the case for brushless motors.

The electric machine 1000 comprises an induction machine portion 1005, and a high-frequency rotary transformer portion 1010. The high-frequency rotary transformer portion 1010 may be similar to the high-frequency rotary transformers described above, but with three transformer cores.

The induction machine portion 1005 comprises a stationary stator 1015 and a rotating rotor 1020. The stationary stator 1015 includes stator windings 1025, and the rotor includes rotor windings 1030 which are configured to rotate relative to the stator windings 1025, as is known in the area of induction machines.

The high-frequency rotary transformer portion 1010 provides a contactless electrical coupling to the rotor 1020. In particular, the three phases of the rotor 1020 (and thus the induction machine portion 1005) are coupled to windings of first, second and third U-shaped primary core elements 1035, which are also physically coupled to the rotor 1020, and thereby rotate therewith. The three phases of the rotor 1020 are therethrough coupled to windings of first, second and third U-shaped secondary core elements 1040.

The air gap between the primary and secondary core elements 1035, 1040 provides contactless coupling with the rotor 1020 and thus rotor windings 1030, rather than using brushes and slip-rings. As a result, the machine 1000 may be more reliable than brush or slip-ring based machines.

The rotor 1020 includes an AC/DC converter/DC/AC inverter 1045. In the case of the machine 1000 comprising an SM, the secondary transformer winding is connected to an AC/DC converter 1045 and then to the rotor windings 1030. In the case of the machine 1000 comprising a DFIG, the secondary transformer winding is connected to an AC/DC converter 1045 and then to a low frequency DC/AC inverter 1045 for the three phase rotor windings 1030.

The electric machine 1000 may comprise a motor or generator, and has various uses, from wind turbines to electric vehicles. The electric machine 1000 may also be modified to function as a high frequency, three-phase transformer.

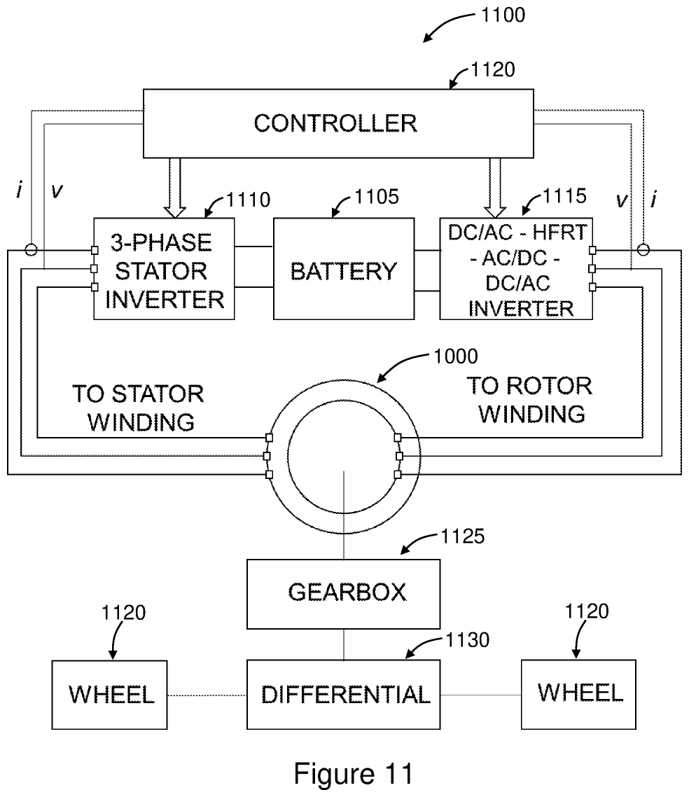

FIG. 11 illustrates a schematic of an electric vehicle 1100 including the electric machine 1000, according to an embodiment of the present invention. The electric machine 1000 may be used as both a motor, when the vehicle 1100 is accelerating, and a generator, when the vehicle 1100 is decelerating.

The vehicle 1100 includes a battery 1105, which is coupled to stator windings of the machine 1000 by a 3-phase stator inverter 1110, and coupled to rotor windings of the machine 1000 by a DC/AC—high-frequency rotary transformer (HFRT)—AC/DC—DC/AC inverter 1115. In particular, the secondary transformer winding of the rotary transformer is connected to an AC/DC converter and then to a low frequency DC/AC inverter for three phase rotor windings of the machine 1000 (DFIM).

A controller 1120 monitors outputs of the 3-phase stator inverter 1110 and the inverter 1115, and uses that as input to control both the 3-phase stator inverter 1110 and the 3-phase rotor inverter 1115 through a wireless control interface. As such, the controller 1120 provides closed loop control of the machine 1000 through the 3-phase stator inverter 1110 and the 3-phase rotor inverter 1115.

A shaft of the rotor of the machine 1000 is coupled to wheels 1120 of the vehicle 1100 through a gearbox 1125 and a differential 1130. As such, when the vehicle 1100 decelerates, the wheels 1120 cause the rotor to rotate, and thereby charge the battery 1105, and when the vehicle accelerates, the battery 1105 powers the machine 1000, thereby causing the rotor to rotate, and thereby the wheels 1120.

In other scenarios, the machine 1000 may be coupled in a variety of ways. Generally, the primary transformer winding will be connected to a DC power source via a high frequency DC/AC converter. The secondary transformer winding can be connected via an AC/DC converter in a number of ways including: (i) connected to a winding of the rotor for a SM; (ii) connected to a three-phase DC/AC inverter for DFIM; or (iii) connected to a DC/AC inverter for a smart power router or solid state transformer. Each of the primary and secondary transformer components can be mechanically and magnetically coupled.

While the above embodiments have described a rotary transformer, the skilled addressee will readily appreciate that the components need not be able to rotate, and the embodiments described above may be adapted to form high-frequency transformers that do not rotate. The use of core elements, such as the core elements 105′, provides an efficient way of building a transformer core, which may be extended and expanded in a modular fashion. As such, the size and shape of the transformer core is not limited by existing manufacturing methods, which are unable to produce large cores effectively.

Similarly, while the above embodiments all include an air gap, the skilled addressee will readily appreciate that such configuration is not required in non-rotating transformers.

The embodiments described above utilise module magnetic core structures, with E- or U-cores (or any shaped core) to construct primary and secondary transformer core structures. An air gap is provided between the primary transformer and the secondary transformer to form a contactless rotary transformer. By comparison, conventional transformers have a closed loop magnetic flux with no air gap.

One area where high frequency transformers according to embodiments of the present invention are particularly suited is in offshore wind turbines. Conventional transformers are generally large, and cannot fit into a wind turbine, and are also costly. The high frequency transformers described herein are compact and may be produced at lower cost.

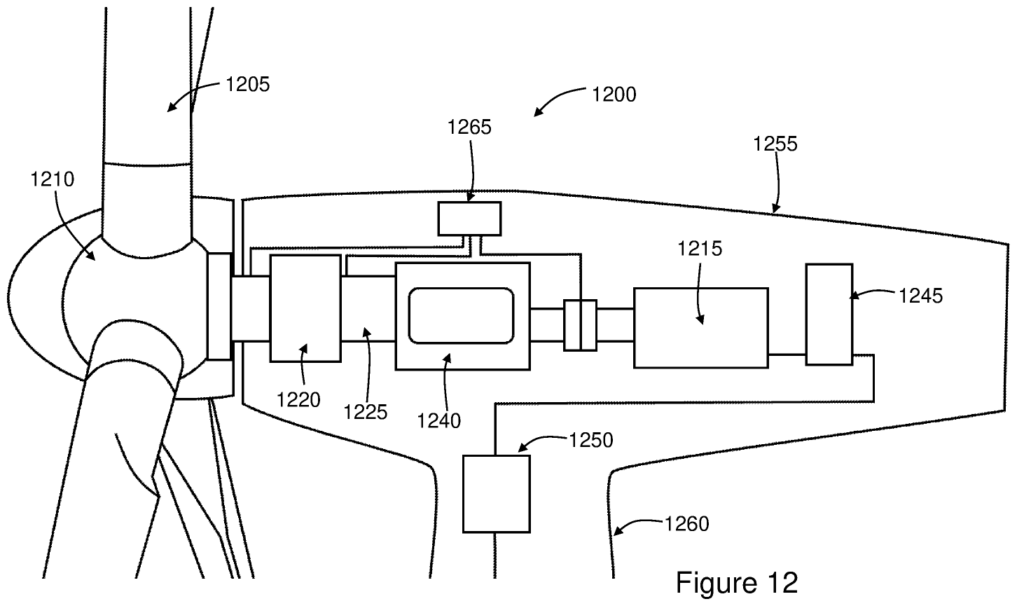

FIG. 12 illustrates a side cut-away view of a wind turbine 1200, according to an embodiment of the present invention. The wind turbine 1200 is particularly suited for off-shore use, and is configured to output DC power, which may be transformed into AC on-shore.

The wind turbine 1200 includes a plurality of blades 1205, coupled to a hub 1210, which are configured to rotate. The hub 1210 is coupled to a generator 1215 by a main support 1220, a main shaft 1225 and a gearbox 1240. Rotation at the generator 1215 creates electricity, which is output to a power converter 1245, and ultimately a high-frequency transformer/DC-DC converter 1250, for transmission to an on-shore transformer.

The high-frequency transformer/DC-DC converter 1250 is similar to the high frequency transformers and converters described above, and is compact, enabling positioning in a base of a frame 1255/top of a tower 1260 of the wind turbine 1200.

In particular, the high frequency transformer 1250 may use a plurality of primary and secondary core elements in such manner enables primary and secondary cores to be created in a modular manner. This enables the transformer 1250 to be easily built to fit the space inside the wind turbine, and using relatively small and easily handled core elements

Finally, the wind turbine 1200 includes mechanical brakes 1265, for braking the turbine 1200.

The use of the high frequency transformer 1250 also provides an efficient means for outputting DC power from the wind turbine, for transmission to a transformer on-shore.

Advantageously, the use of module core structures enables transformer cores to be created which are larger and less expensive than existing cores.

The modular core structures may utilise common iron-based magnetic materials to eliminate the use of brushes, sliprings and rare-earth magnetic materials in motors and generators. This may in turn reduce the manufacturing cost of such motors and generators, and eliminates the need for high-priced rare-earth magnetic materials.

Furthermore, embodiments of the present invention enable magnetic flux to be controlled. In wind turbine applications, for example, this allows for maximised efficiency of the turbine in response to real-time, dynamic conditions. In electric vehicle applications the vehicle torque-speed may be drastically increased. This controllable magnetic flux may also allow for optimised energy transfer between the rotating parts to provide more cost-effective energy production.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A high-frequency rotary transformer including:
a primary transformer core comprising a plurality of primary core elements, each defining a primary transformer winding portion;
a secondary transformer core comprising a plurality of secondary core elements, each defining a secondary transformer winding portion;
a primary winding associated with each of the primary core elements; and
a secondary winding associated with each of the secondary core elements;
wherein the primary transformer core and the secondary transformer core together define a transformer core having a flux pathway linking the primary and secondary windings, and
wherein the primary transformer core and the secondary transformer core are configured to rotate relative to each other.

2. The high-frequency rotary transformer of claim 1, wherein the primary transformer winding portion comprises a channel for receiving the primary transformer winding and the secondary transformer winding portion comprises a channel for receiving the secondary transformer winding.

3. The high-frequency rotary transformer of claim 2, wherein the channels of the primary transformer winding portions are arranged to provide a semi-continuous channel around an axis of the rotary transformer and the channels of the secondary transformer winding portions are arranged to provide a semi-continuous channel around an axis of the rotary transformer.

4. The high-frequency rotary transformer of claim 2, wherein the channels of the primary transformer winding portions are facing corresponding channels of the secondary transformed winding portions.

5. The high-frequency rotary transformer of claim 1, wherein the primary and second core elements are arranged in pairs to define the transformer core.

6. The high-frequency rotary transformer of claim 1, wherein the primary and secondary core elements are at least partly U-shaped.

7. The high-frequency rotary transformer of claim 1, wherein the primary and secondary transformer cores are each substantially axially symmetrical.

8. The high-frequency rotary transformer of claim 1, wherein the primary core and the secondary core are separated by an air gap.

9. The high-frequency rotary transformer of claim 1, wherein the primary and secondary transformer windings are each substantially toroidal in shape.

10. The high-frequency rotary transformer of claim 1, wherein the primary core and the secondary core comprise concentric core portions.

11. The high-frequency rotary transformer of claim 1, wherein the primary core and the secondary core comprise axially separated core portions.

12. The high-frequency rotary transformer of claim 1, wherein the primary and secondary core elements each define multiple primary and secondary transformer winding portions respectively, and the rotary transformer comprises a plurality of primary and secondary windings.

13. The high-frequency rotary transformer of claim 12, wherein the primary and secondary core elements are E-shaped.

14. The high-frequency rotary transformer of claim 1, wherein the high-frequency rotary transformer includes a magnetic flux concentrator, configured to direct magnetic flux towards the primary and secondary core elements.

15. The high-frequency rotary transformer of claim 1, wherein the high-frequency rotary transformer includes a coil intermediate the magnetic flux concentrator and the primary and secondary core elements, and wherein the coil is coupled to the primary winding.

16. The high-frequency rotary transformer of claim 1, wherein the transformer is configured to operate at a frequency of greater than 50 kHz.

17. An electric machine comprising a stationary stator and a rotating rotor, wherein a high-frequency rotary transformer according to claim 1 provides a contactless electrical coupling to the rotor.

18. The electric machine of claim 17, comprising a synchronous machine.

19. The electric machine of claim 17 comprising a doubly-fed induction machine.

20. A high frequency transformer including:
a primary transformer core comprising a plurality of primary core elements, each defining a primary transformer winding portion;
a secondary transformer core comprising a plurality of secondary core elements, each defining a secondary transformer winding portion;
a primary winding associated with each of the primary core elements; and
a secondary winding associated with each of the secondary core elements;
wherein the primary transformer core and the secondary transformer core together define a transformer core having a flux pathway linking the primary and secondary windings.
